(19) United States
(12) Patent Application Publication
(10) Pub. No.: US 2008/0116197 A1
(43) Pub. Date: May 22, 2008

(54) Heater for Aromatic Candles

(76) Inventors: Richard E. Penman, Pleasant View, UT (US); Marilyn F. Penman, Pleasant View, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/943,063

(22) Filed: Nov. 20, 2007

Related U.S. Application Data
(60) Provisional application No. 60/860,064, filed on Nov. 20, 2006.
(60) Provisional application No. 60/961,659, filed on Jul. 23, 2007.

(51) Int. Cl. H05B 3/06; F24J 3/00

(52) U.S. Cl. 219/526; 432/225; 432/9

(57) ABSTRACT

The present invention is a candle heater includes a heating element that is attached to a decorative cover. The heater is adjustable in size allowing it to fit around different sizes and shapes of candles at various positions on the container. The heater allows a person to melt a desired amount of the candle wax increasing the speed and safety of the heater. The heater presents various different ornamental designs which improve the aesthetics of the candle.

### RELATED APPLICATIONS

The present application claims the benefit of U.S. Provisional Patent Application Ser. No. 60/860,064, filed Nov. 20, 2006, which is expressly incorporated herein, and U.S. Provisional Patent Application Ser. No. 60/961,659, filed Jul. 23, 2007, which is expressly incorporated herein.

### BACKGROUND OF THE INVENTION

1. The Field of the Invention

The present invention relates to devices for heating candles or other containers holding scented materials to release the scent or fragrance from these scented products. More specifically, the present invention relates to an improved heating device that wraps around a container to apply heat to the sidewall of the container release a scent or fragrance into the air.

2. State of the Art

Scented candles have become quite common as they are desirable for releasing fragrance into an area. Many people do not wish to burn a scented candle. The burning of a candle consumes the candle over time. More importantly, the burning of a candle creates a fire hazard from the open flame, and also releases soot and other harmful particulates into the air.

Various methods or devices have been developed to heat scented candles to release fragrance. One such method is to place a scented candle on a heating device that conducts heat to the base of the candle, melting the candle and releasing the scent. This method, however, requires significant time to melt the candle and release fragrance, and also poses a larger risk of spilling the candle as the entire quantity of wax is melted. The candle also takes a long time to solidify after melting. Another similar method of heating the candle is to enclose the candle within a heating device to melt the wax. This method also suffers the disadvantages of melting the whole candle as discussed. Also, this tends to obscure the candle and many persons find the candle attractive and wish to see the candle during use.

Another method of heating the candle to release scent is using a heat lamp to apply heat to the top of the candle. This method is generally less efficient than directly applying heat to the candle, and also requires a rather bulky device which obscures the candle from view.

There is thus a need for an improved device that applies heat to a container containing a scented product such as a scented candle. There is need for a device which allows a user to determine how much or how little of the candle is to be melted. There is a need for an adjustable heating device that will allow for use with candles of different sizes. Finally, there is a need for a heating device that includes a decorative outer cover, increasing the aesthetic appeal of the device and the candle used therewith.

### SUMMARY OF THE INVENTION

It is an object of the present invention to provide an improved heating device to apply heat to the sidewalls of a container such as a scented candle to release fragrance from the candle.

According to one aspect of the invention, a heating element is provided that is attached to the sidewalls of a candle. The device forms a ring around the candle and applies heat through the side walls to heat the candle and release fragrance.

According to another aspect of the invention, the heating device may be placed at different heights on the candle to control the amount of the candle which is melted. According to another aspect of the invention, the heater provides a ring shaped heater which is adjustable to fit differing diameter candles.

According to another aspect of the invention, a heating element is provided that outwardly displays a decorative cover.

These and other aspects of the present invention are realized in a heater for aromatic candles as shown and described in the following figures and related description.

### BRIEF DESCRIPTION OF THE DRAWINGS

Various embodiments of the present invention are shown and described in reference to the numbered drawings wherein:

FIG. 1 shows a perspective view of a heater of the present invention;

FIG. 2 shows a side view of the heater of FIG. 1;

FIG. 3 shows a top view of the heater of FIG. 1;

FIG. 4 shows a partial cross-sectional perspective view of the heater of FIG. 1;

FIG. 5 shows a side view of an alternate configuration of the heater of FIG. 1;

FIG. 6 shows a cross-sectional perspective view of the heater of FIG. 1;

FIG. 7 shows a perspective view of the heater of FIGS. 1-6 in use with a candle; and

FIG. 8 shows a partial cross-sectional view of the heater of FIG. 7.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

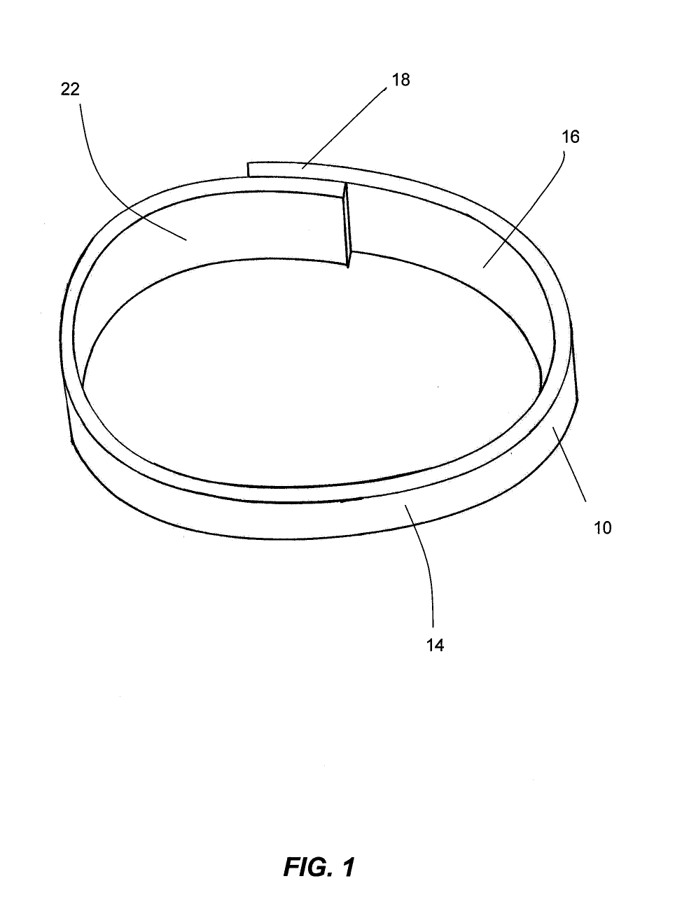

Turning now to FIG. 1, a perspective view of a heater 10 for use with an aromatic candle. As used herein, the term candle refers to a container of a substance, usually a glass container of scented wax. The heater 10 wraps around a candle a single time and heats the wax in the candle to melt the wax and release fragrance from the candle. The heater 10 has a decorative exterior surface 14 which adds to the beauty of the candle and which may allow a person to select a desired decorative exterior to suit their own taste. All or a part of the interior surface 16 of the heater 10 has an electric resistive heater thereon to supply heat to a candle.

The heater 10 is generally elongate, and may have two ends 18, 22 which are fastened together to form a loop. Fastening may preferably be accomplished by hook and loop fasteners or an elastic member and posts, but may also be accomplished by snaps or other alternatives. An alternative embodiment of the heater employs a resilient and generally rigid member which maintains the heater 10 in a circular or semi circular shape such that the heater clips onto a candle and maintains a desired position.

As such, the heater 10 is adjustable in size and may be employed to heat varying sizes of candles, or candles which vary in size along the height of the candle. The heater 10 may be positioned at different locations along the height of a candle to alter the amount of the candle which is melted. The generally ring shaped heater 10 of the present invention can be used to melt the wax which is generally adjacent or above the height of the heater on the candle without melting the wax well below the heater. Thus, a person may choose how much or how little wax is melted. Prior art candle warmers will generally either melt all of the wax in the candle or will only warm the upper surface of the candle. As the heater 10 may be used to melt only the top portion of the wax by providing heat directly to the container, the heater 10 may consume less energy than prior art candle heaters.

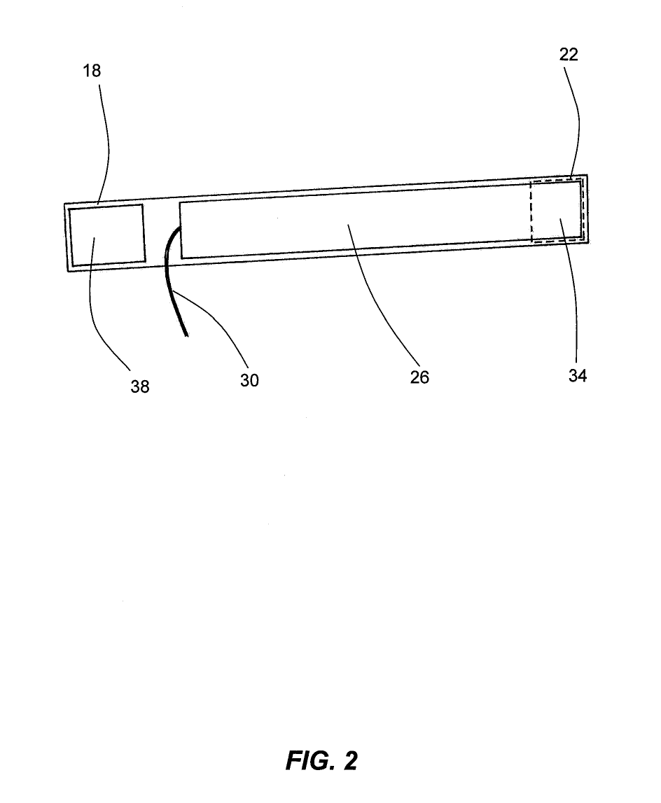

FIG. 2 shows a side view of the inside of the heater 10 of FIG. 1. As discussed, the inside 16 of the heater 10 includes a heating element 26, which will include a cord 30 for connecting the heating element 26 to a power source. The heating element 26 may be a 15 watt electric resistive heater, for example. The heater 10 will include a fastener for connecting the first end 18 and second end 22 together. The fastener may be a hook and loop fastener including a loop portion 34 and hook portion 38. Using an extended loop portion 34 or hook portion 38 would allow a person to adjust the size of the heater 10 to fit different sizes of candles

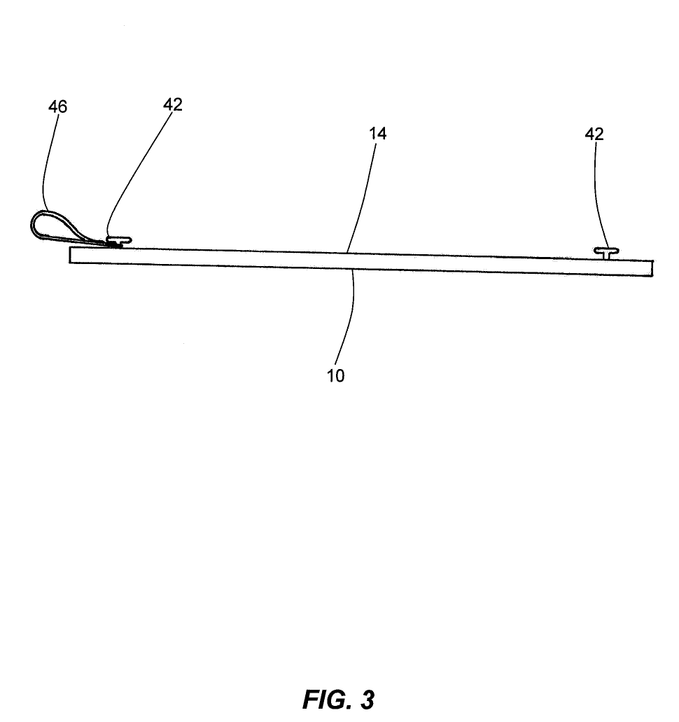

FIG. 3 shows a top view of the heater 10 of FIG. 1, illustrating an alternate fastener. The fastener may include a plurality of posts 42 placed on the outside 14 of the heater 10 and an elastic strap or loop 46 which is drawn between the posts and applies tension to the heater to secure the heater to a candle. The elastic member 46 can stretch and thereby allow the heater 10 to fit a variety of different candle sizes. Additionally, multiple posts 42 may be placed on a single end of the heater 10 at different positions to allow the heater to accommodate different sizes of candles.

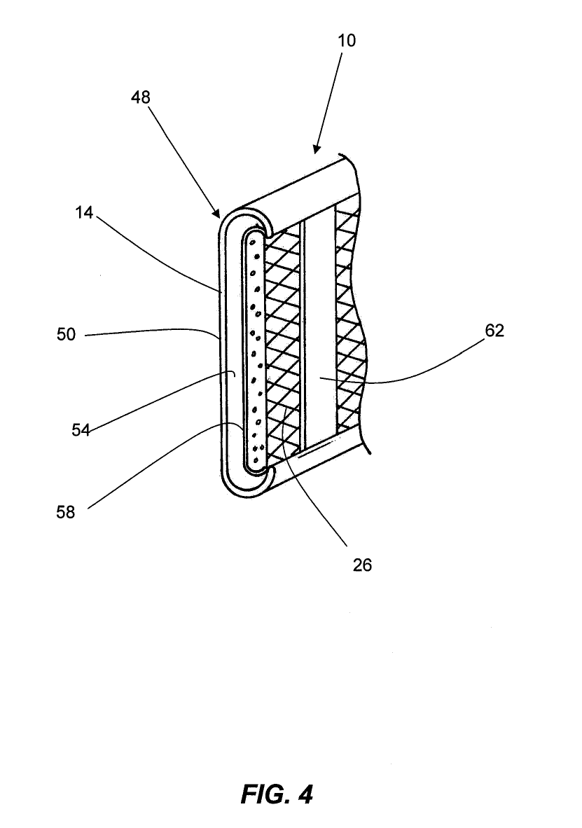

FIG. 4 shows a cut-away perspective view of the heater 10 of FIG. 1. The heater 10 typically includes a decorative cover 50 which forms the outer surface 14 of the heater 10. The decorative cover 50 may be rubber, paper, cloth, leather, or the like as may be desired for a particular aesthetic look, so long as the same is suitable for use with such a heater. The cover 50 may include a variety of decorative designs to enhance the aesthetic appeal of the heater 10. An insulating layer 54 and a heat reflective layer 58 are typically used to separate the cover 50 from the heating element 26. This reduces the temperature of the cover 50 and directs more heat towards a candle, increasing the effectiveness of the heater 10. The cover 50 may wrap around the edges of the heater 10 as shown to cover the edges of the insulating layer 54 and heat reflecting layer 58 and improve the aesthetics of the heater.

It can be seen how the heater 10 may include a separate heating element 26 and a cover assembly 48 which includes loops 62 or another fastener to hold the heating element 26. Such a configuration would allow the heating element 26 to be removed from the cover assembly 48. The cover assembly 48 would include the cover 50, insulating layer 54, heat reflective layer 58, and loops 62. The heating element 26 would be slid between the loops 62 to place it in the cover assembly Such a configuration would allow a person to change the appearance of the heater 10 without replacing the heating element 26 by simply purchasing a different cover assembly 48 and removing the heating element 26 and placing the heating element in the different cover assembly 48.

Where the heating element 26 is not removable from the heater 10, the heater would typically include the cover 50, insulating layer 54, heat reflective layer 58, and heating element 26. The heater 10 would typically not include loops 62 as they would not be necessary.

The heat reflecting layer 58 directs the heat generated by the heating element 26 towards a candle. The insulating layer 54 further limits heat transfer from the heating element 26 to the cover 50 and thereby protects the cover 50 from the heat and improves the efficiency of the heater 10.

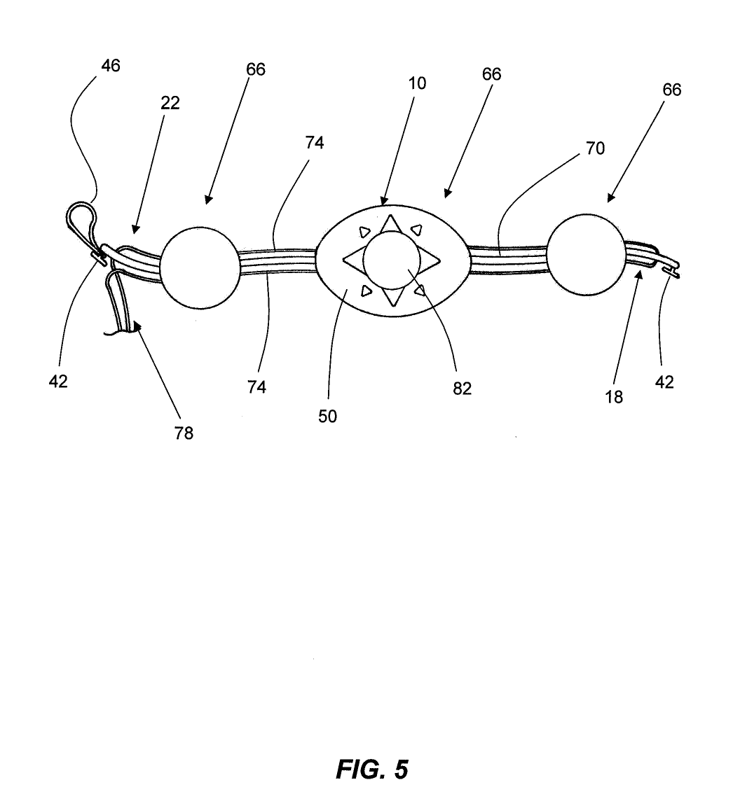

FIG. 5 shows a side view of another embodiment of the heater 10 of FIG. 1. The heater 10 may include multiple separate decorative heating assemblies 66 which each include heating elements 26. Each heater assembly 66 would typically include a cover 50, insulating layer 54, a heat reflective layer 58, and a heating element 26 as shown in FIG. 4. The heating elements 26 may be formed in a similar shape as the cover 50, or may simply be rectangular in shape. Varying numbers of heating assemblies 66 may be used as is desired. If desired, even a single heating assembly 66 may be used.

The heating assemblies 66 are mechanically connected together by a strap 70 or other coupler and are also electrically connected either in series or in parallel by one or more wires 74. It will be appreciated that a single wire 74 may be used where the heating elements 26 are electrically connected in series and that two wires 74 would be necessary to connect the heating elements in parallel. It will also be appreciated that the wires 74 may form the mechanical connection between the heater assemblies 66 if desired. The wires 74 would be connected to a power source as indicated at 78.

The two ends 18, 22 of the heater 10 are fastened together such as with posts 42 and an elastic strap or loop 46. Different fasteners such as hook and loop fasteners, clasps, snaps, etc. could also be used.

The heater 10 of FIG. 5 provides a unique aesthetic appearance. The covers 50 of the heating assemblies 66 could include a decorative design 82 as is desired. The wires 74 and mechanical connection 70 could be quite thin and unobtrusive visually such that the heating assemblies 66 are the most significant visual portion of the heater 10. This would allow a user to have a candle with one or more unique decorative heating assemblies 66 attached to the side of the candle.

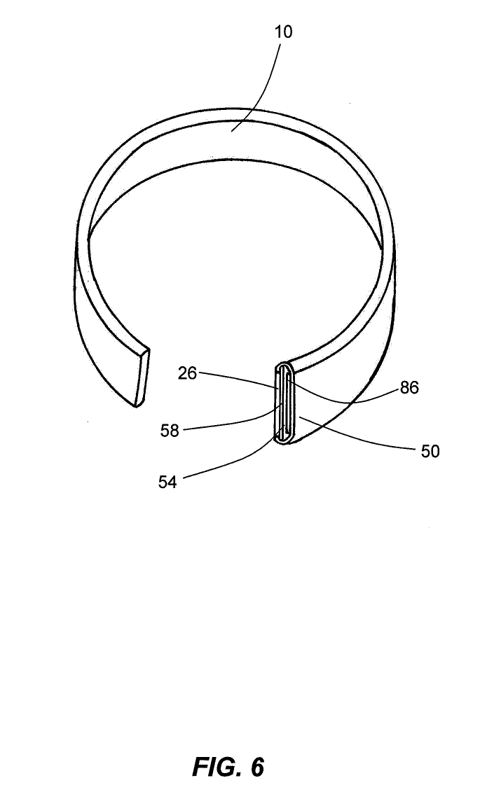

FIG. 6 shows a partial perspective view of an alternate embodiment of the heater 10 of FIG. 1. The heater 10 includes a cover 50, insulating layer 54, heat reflective layer 58, and heating element 26 as previously discussed. The heater also includes a generally rigid resilient member 86 which maintains the shape of the heater 10 while providing some flexibility to the heater. The resilient member 86 may be a piece of spring steel, plastic, fiberglass, a polymer, or other suitable materials. The heater 10 is formed into a semi-circular shape and biased into that shape by the resilient member 86.

In use, the heater 10 may be bent slightly to increase the diameter of the heater so that the heater may be placed over a candle. The resilient member biases the heater 10 into a circular shape and holds the heater 10 onto the candle at the desired position. The resilient member 86 thus allows the heater 10 to be placed at different heights on the candle and allow the heater to be used with candles of different diameters.

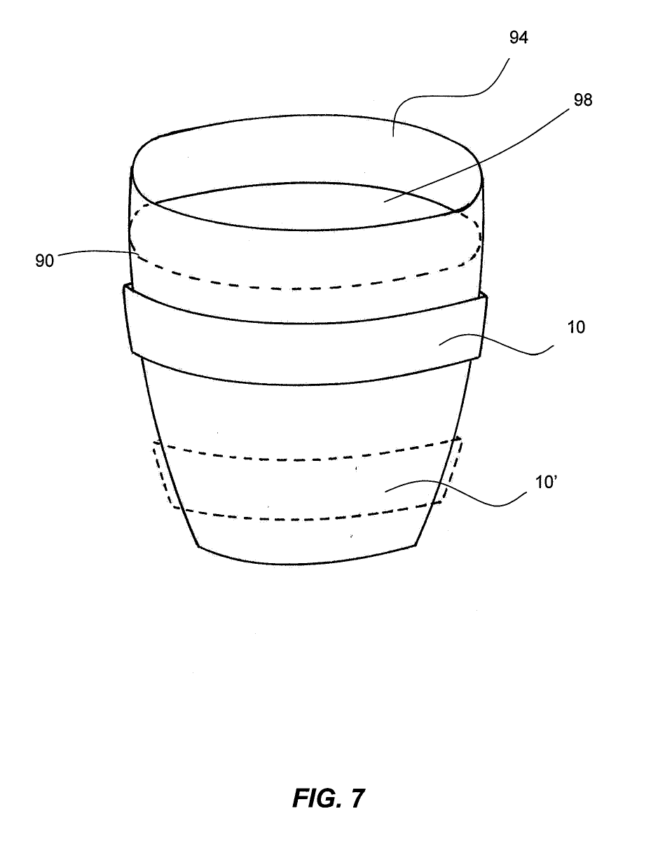

FIG. 7 shows a perspective view of the heater 10 of the previous figures fastened around a tapered candle 90. The candle 90 includes a glass container 94 filled with scented wax 98. As shown, the container 90 is a decorative container which tapers to a smaller diameter at the bottom as compared to the top of the container. The heater 10 as discussed herein is advantageous as it is adjustable to accommodate different diameters of candles. As such, the heater 10 could be moved to a different location on the candle as indicated at 10′ and is thus usable with candles 90 of different diameters and of changing diameters.

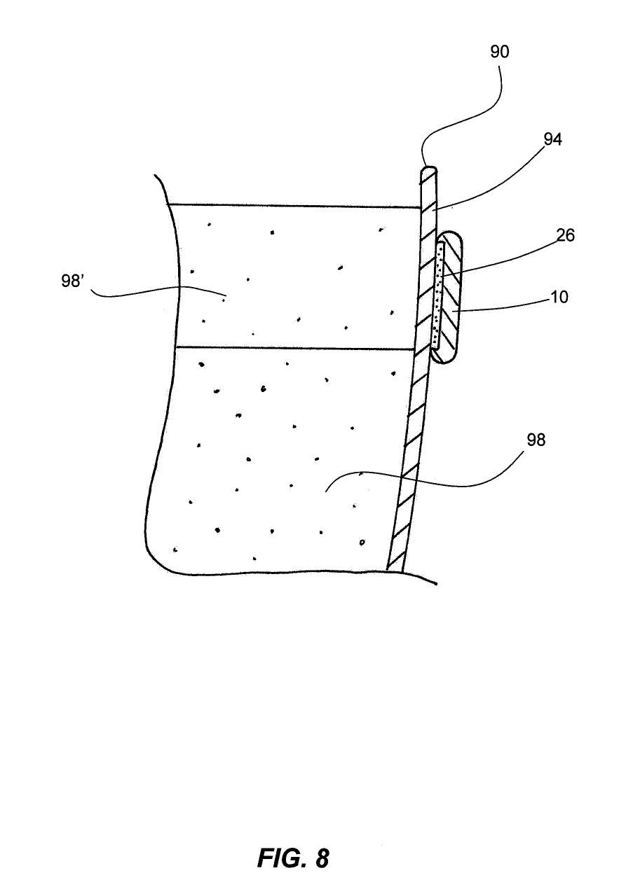

FIG. 8 shows a partial cross sectional view of the candle 90 and heater 10. The heater 10 is fastened to the candle 90 such that the heating element 26 is in contact with the container 94. For clarity, the other structures of the heater 10 are not shown but are understood to be included. A particular advantage of the heater 10 is that a user may choose how much wax 98 to melt, indicated at 98′. The heater 10 will typically melt the wax 98′ which is level with and above the heating element 26, but will not readily melt the wax 98 which is below the heating element 26.

It will be appreciated that the heater 10 may not melt the wax 98′ along a perfectly flat boundary with the un-melted wax 98, but may be used to melt the wax which is generally above the heater and not melt the wax which is generally below the heater. It will also be appreciated that varying the amount of heat provided from the heater 10 to a candle may vary the amount of wax which is melted. A larger amount of heat may melt the entire candle, while less heat than is optimum may not melt any wax. The optimal amount of heat which is provided by the heater 10 may vary according to the size of the candle as well; larger candles requiring more heat.

This has several benefits. First, placing the heater 10 near the top of the candle 90 to only melt the top most portion of the wax 98′ will melt that portion of the candle faster than if the whole candle is to be melted because the heat from the heater is only required to melt a smaller amount of wax. Thus, the candle 90 will emit fragrance faster than if the whole candle is to be melted. A smaller amount of melted wax 98′ will also solidify faster than a larger quantity of melted wax, causing the candle to stop emitting fragrance faster when the user no longer desires fragrance. Thus, the heater 10 is more convenient to use as it may speed up how quickly the candle 90 starts and stops to emit fragrance.

Additionally, the heater 10 is safer to use than many available method and devices for melting candles. As the user may choose to only melt the top portion of the wax 98′, there is less molten wax present if the candle is accidentally bumped or knocked over, reducing the risk of burns or damage to surrounding equipment or furniture. Additionally, the smaller quantity of melted wax 98′ will solidify faster, reducing the time period during which spilling the melted wax 98′ is a concern. It will be appreciated that wax is often quite difficult to remove from fabrics and other surfaces and, as such, the reduced risk of spilling the wax is quite beneficial to a user. As the user may choose to melt on a small portion of the wax 98′, the risk of spilling may be significantly reduced.

There is thus disclosed an improved aromatic container heater cover assembly. It will be appreciated that numerous changes may be made to the present invention without departing from the scope of the claims.

What is claimed is:

1. A candle heater comprising:
a heating element;
a cover disposed over at least a portion of the heating element such that an outer side of the heating element is covered by the cover;
means for attaching the heater to a candle such that the heater generally forms a ring around the sidewall of a candle container.

2. The candle heater of claim 1, wherein the heater further comprises an insulating layer disposed between the heating element and at least a portion of the cover to inhibit heat transfer from the heating element to the cover.

3. The candle heater of claim 1, wherein the heater further comprises a heat reflecting layer disposed between the heating element and at least a portion of the cover to direct heat generated by the heating element towards a candle.

4. The candle heater of claim 3, wherein the heater further comprises an insulating layer disposed between the heat reflecting layer and the cover.

5. The candle heater of claim 1, wherein the means for attaching the heater to a candle comprises hook and loop fastener.

6. The candle heater of claim 1, wherein the means for attaching the heater to a candle comprises a plurality of posts and an elastic member.

7. The candle heater of claim 1, wherein the heater is adjustable in size so as to accommodate candles of varying diameter.

8. The candle heater of claim 1, wherein the outside of the cover has a decorative appearance.

9. The candle heater of claim 1, wherein the heater comprises multiple individual heating elements connected together.

10. The candle heater of claim 9, wherein the individual heating elements are electrically connected together.

11. The candle heater of claim 10, wherein the individual heating elements are also mechanically connected independent of the electrical connection.

12. The candle heater of claim 1, wherein the individual heating elements each have a decorative cover that is displayed outwardly when the heater is attached to a candle.

13. The candle heater of claim 1, wherein the means for attaching the heater to a candle comprises a generally resilient member which biased the heater into a circular shape and holds the heater onto a candle.

14. The candle heater of claim 1, wherein the heater is attached to the candle so as to form a single ring around the candle.

15. A method for heating a candle comprising:
selecting a candle, the candle comprising a container having scented substance therein;
selecting a candle heater, the candle heater comprising an electric heating element;
placing the heater around a sidewall of the candle container such that the heater generally forms a ring around the candle; and
energizing the electric heating element so as to melt the scented substance and thereby release fragrance from the candle.

16. The method of claim 15, wherein the method further comprises positioning the heater such that the heater is at a single height around the sidewall of the candle container.

17. The method of claim 15, wherein the method further comprises energizing the heating element so as to melt most of the wax which is generally above the heating element and so as to not melt most of the wax which is generally below the heating element.

18. The method of claim 15, wherein the method further comprises adjusting the height of the heater relative to the candle container sidewall to adjust the amount of wax which is melted by the heater.

19. The method of claim 15, wherein the method further comprises adjusting the diameter of the heater so as to accommodate candles of varying diameter.
